(19) United States
(12) Patent Application Publication
(10) Pub. No.: US 2014/0278854 A1
(43) Pub. Date: Sep. 18, 2014

(54) SYSTEM, DEVICE, AND METHOD FOR PROVIDING ACCESS TO DATA CONTENT VIA AN INTERACTIVE FEATURE

(71) Applicants: Jack Bertram Coronel, Las Vegas, NV (US); Joseph R. Coronel, Las Vegas, NV (US)

(72) Inventors: Jack Bertram Coronel, Las Vegas, NV (US); Joseph R. Coronel, Las Vegas, NV (US)

(21) Appl. No.: 13/844,598

(22) Filed: Mar. 15, 2013

(51) Int. Cl. G06Q 30/02

(52) U.S. Cl. CPC G06Q 30/0209
USPC 705/14.12; 705/14.1

(57) ABSTRACT

Systems and devices for providing access to data content via an interactive feature include a user device in communication with a content server that stores data content. An interactive feature is conducted on the user device. The interactive feature includes selectable interactive elements which, at least in part, provide the interactivity within the interactive feature. A determination is made whether an achievement has been earned through the interactive feature. If an achievement is earned, the content server provides access to the user device to data content. Optionally, data content is exclusive insofar as it is only accessible in response to an achievement.

### FIELD OF THE INVENTION

The present invention includes systems and devices for providing access to data. More specifically, the present invention is a system and device for providing access to data through an interactive feature such as an interactive game, interactive book, interactive video, or the like.

### SUMMARY OF THE INVENTION

The present invention includes systems, devices, and methods for conducting an interactive feature and allowing access to data content to users who have attained an achievement through the interactive feature. In one optional embodiment, a system includes at least one user device. In one such optional embodiment, a user device includes a data processor, a display in communication with the data processor, a user interface in communication with the data processor, and a data storage device in communication with the data processor. In one optional embodiment, the data storage device stores program instructions executable by the data processor. Optionally, the program instructions include displaying an interactive feature at the display having a plurality of selectable feature elements. The interactive feature could take any form, including a game, an interactive video, an interactive book, or the like.

The interactive feature is conducted by the data processor utilizing the feature elements. The interactive feature includes receiving input through the user interface to select at least one feature element. The data processor determines whether the interactive feature has resulted in the award of an achievement that may be earned through the interactive feature.

A system also includes a content server in communication with the user device. In an optional embodiment, the content server includes a data storage device adapted to store data content and program instructions executable by the polling server. In one such optional embodiment, the program instructions include receiving notification of the award of an achievement and allowing access by the user device to the data content in response to receipt of the notification. In an optional embodiment, the content server may restrict access to the data content such that the data content is only accessible in response to receipt of the notification. The data content may take any form, including a voucher exchangeable for at least one of goods and services, a voucher exchangeable for a discount on at least one of goods and services, a digital good (such as music, videos, books, games, or the like), or the like.

For example, in one particular application of the present invention, the data processor at the user device displays an interactive game at the display. In an optional embodiment, a required payment is received through the user interface as a condition of conducting the interactive game. In another optional embodiment, no payment is required to conduct the interactive game.

The interactive game includes a plurality of game elements. The interactive game is conducted by the data processor utilizing the game elements. In an optional embodiment, the interactive game includes selection of at least one game element. In one such optional embodiment, game elements may be randomly selected by the data processor. In another optional embodiment, the interactive game includes receiving input through the user interface to select at least one game element. Yet another optional embodiment may include both random selection and user selection of game elements. The data processor determines whether the interactive game has resulted in the award of an achievement that may be earned through the interactive game.

A content server communicates with the user device and executes program instructions executable by the content server to receive notification of the award of an achievement and allow access by the user device to the data content in response to receipt of the notification. In an optional embodiment, the data content is exclusive insofar as the content server restricts access to the data content except in response to receipt of the notification.

### BRIEF DESCRIPTION OF THE DRAWINGS

FIG. 1 is a block diagram of a system according to an embodiment of the present invention;

FIG. 2 is a block diagram of a user device according to an embodiment of the present invention;

FIG. 3 is a flowchart of a method according to an embodiment of the present invention.

### DESCRIPTION

Reference is now made to the figures wherein like parts are referred to by like numerals throughout. With general reference to FIGS. 1-3, the present invention is directed to the use of interactive features to interact with end users and draw end users to data content. As shown in FIGS. 1-3, a system according to the present invention includes a content server 100. The content server 100 communicates with one or more user devices 102. The content server 100 may take many different forms. In an optional embodiment, the content server 100 is a file server that communicates with a computer network, such as the Internet.

User devices 102 may likewise take many different forms. For example, user devices 102 may include personal computers, mobile phones, tablet devices, kiosks, handheld devices, PDAs, interactive televisions, or the like. It is contemplated that the user devices 102 may include a mixture of types of devices, e.g. some users may use a personal computer while other users use a mobile phone, tablet device, kiosk, and/or other devices. Consequently, it is also contemplated that the user devices 102 may communicate with the content server 100 in a variety of different ways including via the Internet 104 or other forms of computer networks such as LAN, WAN, or the like, via broadcast media 106 such as television, radio, or the like, or via service providers 108 such as satellite or cable service providers, WiFi, interactive television, publicly switched telephone networks, broadband cellular telephone networks, or the like.

In an optional embodiment, users may be associated with user accounts. In such an optional embodiment, information for user accounts may be collected automatically or manually. For example, in an optional embodiment in which the user information is automatically collected, the user information may be copied from an existing record, such as a customer profile, user profile on a social media network, or the like. Additionally or alternatively, user information may be received manually, such as through a user interface 206 at the user device 102.

In an optional embodiment, the user information is stored in a record associated with the user's account. In one such optional embodiment, the records are stored in a database at a content server 100 and/or a record stored at a user device 102.

In alternate optional embodiments, users may be identified through means other than user accounts, such as the user device 102, an application loaded onto the user device 102, or the like. For example, in an optional embodiment in which the present invention includes program instructions on the user device in the form of software or firmware, the software or firmware may include a unique identifier so that communication from the user device 102 may be identified.

More specifically, in one such optional embodiment illustrated in FIG. 2, a user device 102 may include a data processor 202 in communication with a display 204, user interface 206, and data storage device 208. As discussed above, the form of the user device 102 may vary depending on the embodiment. For example, the user device 102 may take the form of a personal computer, mobile phone, tablet device, kiosk, or the like.

The user device 102 is configured to execute program instructions. In one such optional embodiment, program instructions are stored at a data storage device 208 in the form of software or firmware and executed by the data processor 202. It is noted that the data storage device 208 may be local to the user device 102 or remote from the user device. For example, the program instructions may be an application (or “app”) that is downloaded and installed on the user device 102. Alternatively, the program instructions may be stored remotely, such as at a file server, cloud storage, or the like. In an optional embodiment, the program instructions include instructions to conduct an interactive feature and communicate with the content server 100.

For example, in one optional embodiment illustrated in FIG. 3, an interactive feature may be displayed 302. The interactive feature may take any form, including an interactive video, an interactive game, an interactive book, an interactive chart or diagnostic tool, or the like. As used herein, “interactive” refers to the inclusion of interactive elements within the interactive feature which are selectable. It is contemplated that the interactive elements may be selected by the data processor 202 (optionally through a random number generator), a user (such as through a user interface 206), another user in a multiplayer feature conducted via a network such as the Internet, or the like.

In one such optional embodiment, the content server 100 stores the interactive feature and the user device 102 functions as a remote terminal to the remotely stored interactive feature. In another optional embodiment, the user device 102 stores (or downloads from the content server 100) the interactive feature. The transmission may occur unprompted, e.g., such as in a periodic update, or upon a prompt from the user device 102, e.g., such as upon installing an application, commencing a game, or the like.

The interactive feature is conducted 304 at the user device 102. In an optional embodiment, the user device 102 includes a user interface 206 which is used to interact with the interactive feature. For example, the interactive feature may include prompts which require commands or other inputs to conduct the interactive feature. In an optional embodiment, the user interface 206 may be used to interact with selectable interactive elements within the interactive feature.

The result of the interaction with the interactive feature prompts a determination 306 whether an achievement has been earned through the interactive feature. For example, completion of an interactive feature, such as an interactive game, interactive video, interactive book, or the like, may earn an achievement. Conversely, mere completion may be a necessary, but not sufficient, condition to earning an achievement. In such examples, something more may be required, such as a particular score in a game, collecting interactive elements in a game or book, identifying interactive elements in a video or book, or the like. As may be appreciated, any criterion or criteria may be used to determine whether interaction with an interactive feature earns an achievement.

While the achievement may be redeemed for any of a variety of prizes, rewards, or the like, in one optional embodiment, the achievement is redeemed at the content server 100 for access to a data content. More particularly, in an optional embodiment, the content server 100 receives 308 notification of the achievement. In one optional embodiment, the content server 100 may receive notification of the achievement from the user device 102. In another optional embodiment, an achievement may be stored in a user record and the content server 100 may be notified based on the change to the user record. In yet another optional embodiment, achievements may be stored on the user device 102 and the content server 100 may be notified when the user device 102 attempts to access the data content.

In any event, the content server 100 provides 310 access to data content in response to the notification of the achievement. the data content accessible as a result of the achievement may take any form. For example, the data content may include a voucher for goods or services or a discount on goods or services. In another example, data content may include video, music, books, games, turns or plays of games, or the like. As may be appreciated, the data content may be sponsored, or may be informational, or may be entertainment, or may have any other purpose. In an optional embodiment, the data content is exclusive and can only be accessed in if an achievement has been earned. The data content may be provided in any fashion, including by downloading to the user device, streaming to the user device, or the like. Additionally or alternatively, the data content may be viewable or accessible from the content server 100, without actually storing any data on the user device 102.

For example, in one optional embodiment, the interactive feature may include an interactive game. In one such optional embodiment, program instructions generate a game field for display at the user device 102. In one optional embodiment, the game field may be generated at the content server 100 and transmitted to the user device 102 with, or without, the interactive game elements. In another optional embodiment, the user device 102 may generate a game field. In yet another optional embodiment, the game field may be generated by an outside game field generator and transmitted to the content server 100 and/or user device 102.

The game field is displayed at the display 204 and includes a plurality of interactive game elements. Interaction with the game elements produces a game outcome. For example, the game could be a target game and game elements could include graphical images of targets; the game could be a card game and game elements could be playing cards; the game could be a racing game and game elements could include graphical images of racers; and so forth. It is contemplated that the game field may be dynamically generated by the content server 100, user device 102, or a combination thereof. Alternatively, the game field may be a substantially static template which is filled in with game elements.

The user device 102 conducts the game. The nature of the game may take any form. For example, the game may be a skill game or chance game. Likewise, the game may include interactive graphics or may be text-based, such as a puzzle or trivia game. In an optional embodiment, the game elements may be differentiated using graphics, text, or the like.

In an optional embodiment, the game is conducted at the user device 102 which receives input through the user interface 206 to conduct the game.

As the game is conducted, the game elements are selected. The user interface 206 may receive input to prompt the data processor 202 to select game elements (such as in a game of chance) or the user interface may receive input to directly select game elements (such as in a skill game).

In an optional embodiment, the data processor 202 records the selection of game elements to determine the outcome of the game. The outcome of the interactive game may include a score, or the accomplishment (or failure to accomplish) some defined task. In an optional embodiment, the outcome of the game may determine, at least in part, whether an achievement is earned. As noted above, the threshold for earning an achievement could essentially be zero, with every user earning an achievement. Alternatively, the threshold may require the user to accomplish at least something within the interactive game to earn an achievement.

The data processor 202 may store and/or transmit the achievement or notification of an achievement to the content server 100. As may be appreciated, there may be a variety of different achievements and a user may earn one or multiple achievements, each of which may be treated differently by the content server 100, i.e., may entitle the user to access different data content.

While certain embodiments of the present invention have been shown and described it is to be understood that the present invention is subject to many modifications and changes without departing from the spirit and scope of the claims presented herein.

1. A system comprising:
at least one user device comprising:
a data processor;
a display in communication with said data processor;
a user interface in communication with said data processor; and
a data storage device in communication with said data processor adapted to store program instructions executable by said data processor to conduct the steps of:
displaying an interactive feature at said display having a plurality of selectable feature elements;
conducting said interactive feature by said data processor utilizing said feature elements, wherein said interactive feature includes receiving input through said user interface to select at least one feature element; and
determining by said data processor whether said interactive feature has resulted in the award of an achievement that may be earned through said interactive feature; and
a content server in communication with said user device including a data storage device configured to store data content in the form of a sponsored digital good, wherein said data content is separate from and outside of said interactive feature and logically independent of said interactive feature, and program instructions executable by said content server to conduct the steps of:
receiving notification of the award of an achievement; and
allowing access by said user device to said data content in response to receipt of said notification of the award of an achievement to thereby utilize said interactive feature as a means to deliver said data content to said user device upon receipt of said achievement at said content server.

2. The system of claim 1 wherein said interactive feature comprises a game.

3. The system of claim 1 wherein said interactive feature comprises an interactive book.

4. The system of claim 1 wherein said interactive feature comprises an interactive video.

5-7. (canceled)

8. The system of claim 7 wherein said program instructions executable by said content server further comprise restricting access to said data content such that said data content is only accessible in response to receipt of said notification.

9. A system comprising:
at least one user device comprising:
a data processor;
a display in communication with said data processor;
a user interface in communication with said data processor; and
a data storage device in communication with said data processor adapted to store program instructions executable by said data processor to conduct the steps of:
displaying an interactive game at said display having a plurality of game elements;
conducting said interactive game by said data processor utilizing said game elements, wherein said interactive game includes selection of at least one game element; and
determining by said data processor whether said interactive game has resulted in the award of an achievement that may be earned through said interactive game based, at least in part, on said game elements; and
a content server in communication with said user device including a data storage device adapted to store data content in the form of a sponsored digital good, wherein said data content is separate from and outside of said interactive feature and logically independent of said interactive feature, and program instructions executable by said content server to conduct the steps of:
receiving notification of the award of an achievement; and
allowing access by said user device to said data content in response to receipt of said notification of the award of an achievement to thereby utilize said interactive feature as a means to deliver said data content to said user device upon receipt of said achievement at said content server.

10-11. (canceled)

12. The system of claim 9 wherein said program instructions executable by said user device further comprise receiving payment through said user interface, such that said interactive game is conducted in response to receipt of said payment.

13. (canceled)

14. The system of claim 13 wherein said program instructions executable by said content server further comprise restricting access to said data content such that said data content is only accessible in response to receipt of said notification.

15. A system comprising:
at least one user device comprising:
a data processor;
a display in communication with said data processor;
a user interface in communication with said data processor; and
a data storage device in communication with said data processor adapted to store program instructions executable by said data processor to conduct the steps of:
displaying an interactive game at said display having a plurality of selectable game elements;
conducting said interactive game by said data processor utilizing said game elements, wherein said interactive game includes receiving input through said user interface to select at least one game element; and
determining by said data processor whether said interactive game has resulted in the award of an achievement that may be earned through said interactive game based, at least in part, on said game elements; and
a content server in communication with said user device including a data storage device adapted to store data content in the form of a sponsored digital good, wherein said data content is separate from and outside of said interactive feature and logically independent of said interactive feature, and program instructions executable by said content server to conduct the steps of:
receiving notification of the award of an achievement;
allowing access by said user device to said data content in response to receipt of said notification of the award of an achievement to thereby utilize said interactive feature as a means to deliver said data content to said user device upon receipt of said achievement at said content server; and
restricting access to said data content such that said data content is only accessible in response to receipt of said notification of the award of an achievement.

16-17. (canceled)

18. The system of claim 15 wherein said program instructions executable by said user device further comprise receiving payment through said user interface, such that said interactive game is conducted in response to receipt of said payment.

19. (canceled)
